(19) United States
(12) Patent Application Publication
(10) Pub. No.: US 2005/0193783 A1
(43) Pub. Date: Sep. 8, 2005

(54) Security device, security system including the security device and security method using the security system

(76) Inventors: David Zovic, Brampton (CA); John Schipani, Mississauga (CA); Peter Padula, Mississauga (CA); Carmine Santarelli, Mississauga (CA)

Correspondence Address: Thomas N. Young;YOUNG & BASILE P.C., 3001 West Big Beaver Road, Suite 624, Troy, MI, 48084, US

(21) Appl. No.: 10/790,893

(22) Filed: Mar. 2, 2004

(51) Int. Cl. E05B 65/52

(52) U.S. Cl. 70/69

(57) ABSTRACT

A security device for use with a disposable strap and a piece of luggage is disclosed. The piece of luggage with which the device is used has cooperating parts adapted to receive the shackle of a padlock or the like to permit the piece of luggage to be locked closed. The security device comprises a link for receiving said strap. When in receipt of the strap, the link securely links longitudinally spaced-apart portions thereof. Thus, when the strap is operably received by the cooperating parts in the manner of a shackle, and the strap is operably received by the linking means, the piece of luggage cannot be opened.

### FIELD OF THE INVENTION

The present invention relates to the field of security, more particularly, to security for airports and the like.

### BACKGROUND OF THE INVENTION

Airport security issues have become of significant interest in recent years. Currently, travellers intending to board an aircraft are typically required to deposit luggage and other baggage with airline staff at a check-in facility. Each piece of luggage is tagged with a sticker, hang-tag or the like at the check-in facility and then transferred to the hold of the aircraft. In the course of the transfer process, the piece of luggage is inspected. Inspection usually involves, at a minimum, some form of electronic inspection, such as x-ray imaging. Sensors for detecting trace elements of explosives and/or drugs may also be employed. If the electronic inspection suggests the possible presence of unauthorized material, the piece of luggage will be opened and subjected to visual contents inspection. As a result of the possible need for visual contents inspection, the piece of luggage cannot be locked by the traveller, unless he or she wishes to assume the risk of it being forced open and damaged. The unsecured nature of the piece of luggage permits its contents to be altered, inter alia, by baggage handlers, which is problematic in terms of possible contents theft, as well as the possible introduction of contraband into the luggage.

### SUMMARY OF THE INVENTION

A security device for use with a disposable strap and a piece of luggage forms one aspect of the present invention. The piece of luggage has cooperating parts adapted to receive the shackle of a padlock or the like to permit the piece of luggage to be locked closed. The security device comprises a linking means for receiving the strap and, when in receipt of the strap, for securely linking longitudinally spaced-apart portions thereof such that, in use, when the strap is operably received by the cooperating parts of the piece of luggage and the strap is operably received by the linking means, the piece of luggage cannot be opened.

A security device for use with a disposable strap, a key and a piece of luggage forms another aspect of the present invention. The piece of luggage has cooperating parts adapted to receive the shackle of a padlock or the like to permit the piece of luggage to be locked closed. The security device comprises a linking means for receiving the strap and, when in receipt of the strap, for securely linking longitudinally spaced-apart portions thereof such that, in use, when the strap is operably received by the cooperating parts of the piece of luggage and the strap is operably received by the linking means, the piece of luggage cannot be opened. In this aspect of the invention, the linking means includes a lock mechanism manipulable upon insertion of the key from a locked configuration to an unlocked configuration and adapted to receive the strap only when the lock mechanism is the unlocked configuration.

Other aspects, advantages, features and characteristics of the present invention, as well as methods of operation and use and functions of the related elements of the structure, and the combination of parts and economies of manufacture, will become apparent upon consideration of the following detailed description and the appended claims with reference to the accompanying drawings, the latter of which is briefly described hereinafter.

### BRIEF DESCRIPTION OF THE DRAWINGS

In the attached drawings, wherein like parts are identified with like identifiers:

FIG. 1 is a perspective view of a security system according to a preferred embodiment of the present invention, the security system including a security device, a key and a strap;

FIG. 2 is a partially exploded perspective view of the security device of FIG. 1;

FIG. 3 is a fully exploded view of the security device of FIG. 1;

FIG. 4 is a top plan view of a portion of the structure of FIG. 2, with a lock mechanism thereof shown in an unlocked configuration;

FIG. 5 is a view of the structure of FIG. 2, with the security strap of FIG. 1 about to be inserted therein;

FIG. 6 is a view of the structure of FIG. 5, with the security strap threaded through the security device;

FIG. 7 is a view of the structure of FIG. 6, with a slider part thereof disposed at a second position thereof;

FIG. 8 is a view of the structure of FIG. 7, a the latch portion thereof rotated counterclockwise relative to its position in FIG. 7;

FIG. 9 is a view of the structure of FIG. 8, with the security strap cut into halves;

FIG. 10 is a view of the structure of FIG. 9, with the halves of the security strap removed from the security device;

FIG. 11 is a view of the structure of FIG. 10, with the latch shown at a first position thereof; and

FIG. 12 is a view of the structure of FIG. 11, with the key of FIG. 1 inserted therein and the latch shown at a second position thereof.

### DETAILED DESCRIPTION

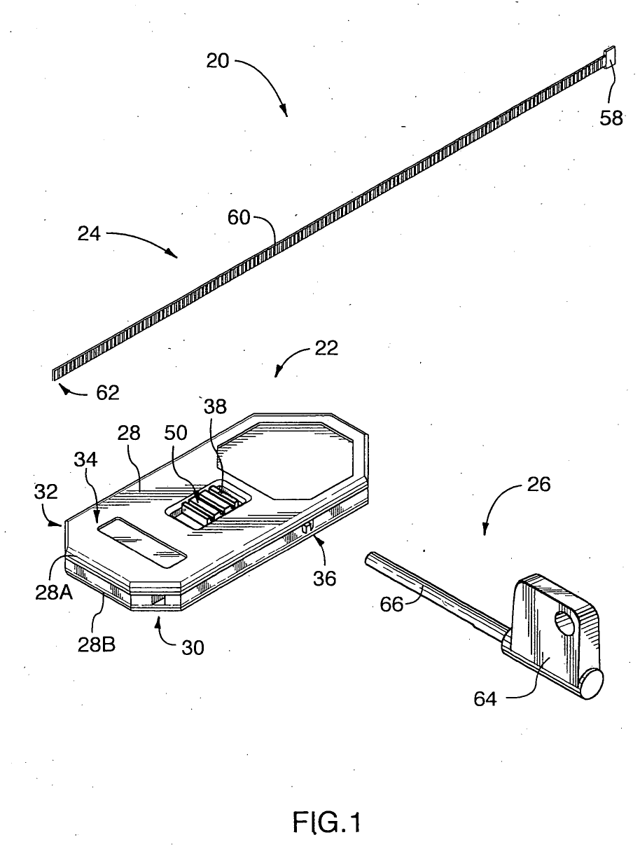

FIG. 1 illustrates a security system 20 according to a preferred embodiment of the present invention. The security system 20 will be seen to include a security device 22, a disposable security strap 24 and a security key 26, which are hereinafter discussed in detail, in turn.

With continuing reference to FIG. 1, the device 22 will be seen to include a housing 28 formed of cooperating housing cover 28A and housing body 28B portions. The housing cover portion 28A and the housing body portion 28B are each formed of plastic, and are sonically welded to one another in use. The housing 28 has a pair of passageways 30,32 defined therethrough, said pair of passageways 30,32 consisting of a first passageway 30 and a second passageway 32. The housing 28 also defines a viewing window 34; a keyway 36 intersecting the first passageway; and an elongate slot 38. The keyway 36 is generally U-shaped in cross-section.

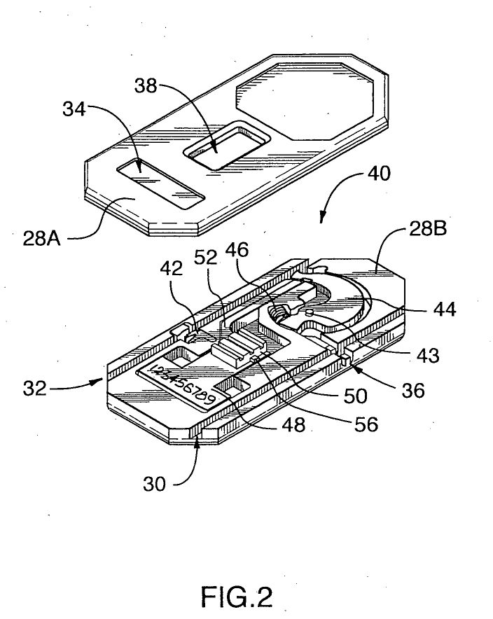

As best seen in FIG. 2, the security device 22 also includes a lock mechanism 40 and a pawl 42.

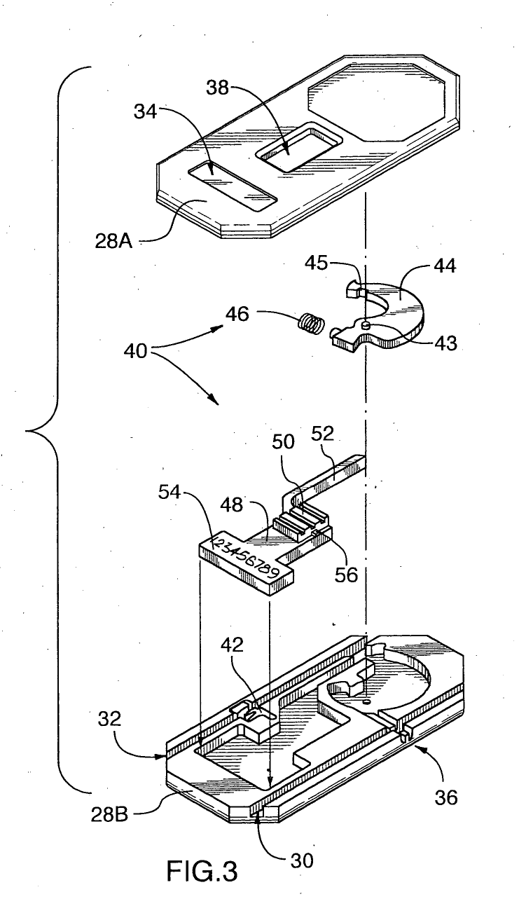

The components of the lock mechanism 40 as well illustrated in FIG. 3 to include includes a latch 44, a spring 46, a slider 48 and a button 50.

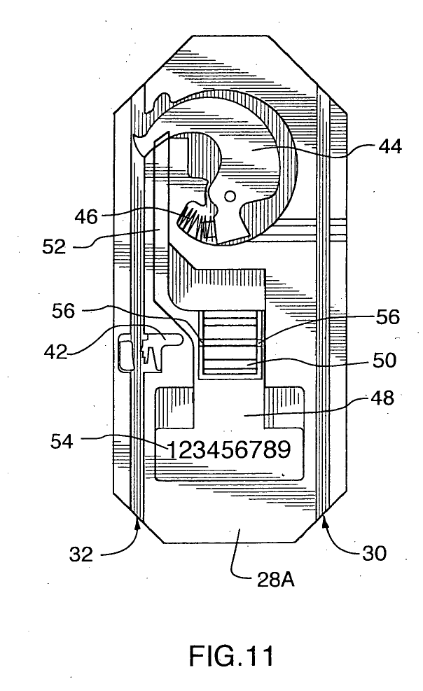

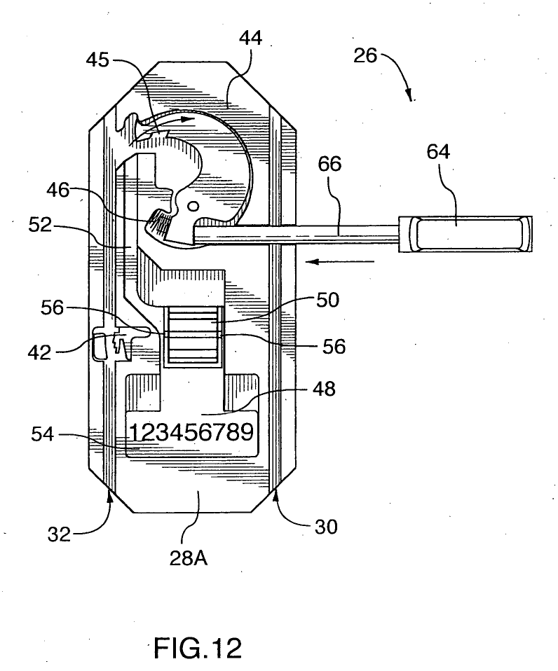

The latch 44 is rotatably mounted interiorly of the housing 28 via a pin portion 43 for movement between a first position, shown in FIG. 11, whereat a portion of the latch 44 lies across one of the passageways, specifically, the second passageway 32, and a second position, shown in FIG. 12, whereat the latch 44 is disposed apart from the second passageway 32. The latch 44 has a notch 45 defined thereon.

The spring 46 biases the latch 44 for movement to its first position.

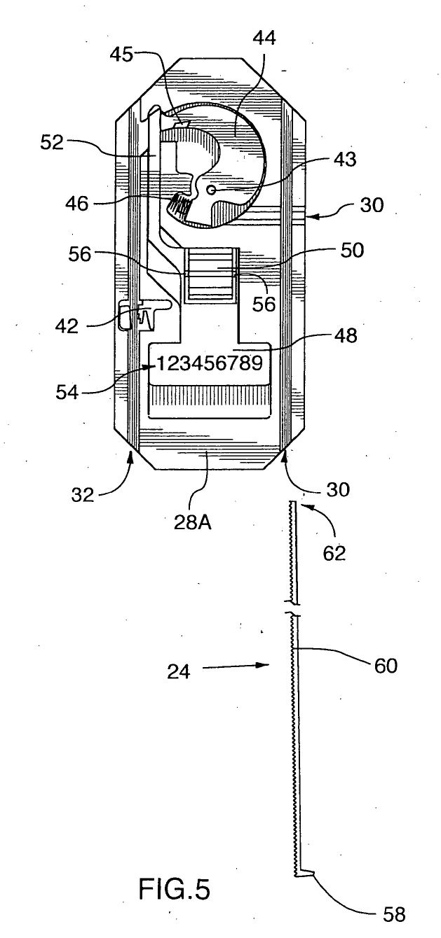

The slider 48 is mounted interiorly of the housing 28 for sliding movement between first and second positions, shown respectively in FIG. 5 and FIG. 12. The first position of the slider 48 is a position of interference with the first position of the latch 44. That is, the same space is occupied by the latch 44 when in its first position, and by the slider 48 when in its first position. Thus, movement of the latch 44 to its first position is precluded when the slider 48 is at its first position, and movement of the slider 48 to its first position is precluded when the latch 44 is at its first position. Such interference is provided in the slider 48 of this embodiment by an elongate arm 52 portion of the slider 48 which lies in the path of rotation of the latch 44 when the slider 48 is in its first position. The second position of the slider 48 is a position of non-interference. The first position of the slider 48 defines an unlocked configuration of the lock mechanism 40. The slider 48 has indicia 54 visible through the viewing window 34 when the slider 48 is disposed at its second position.

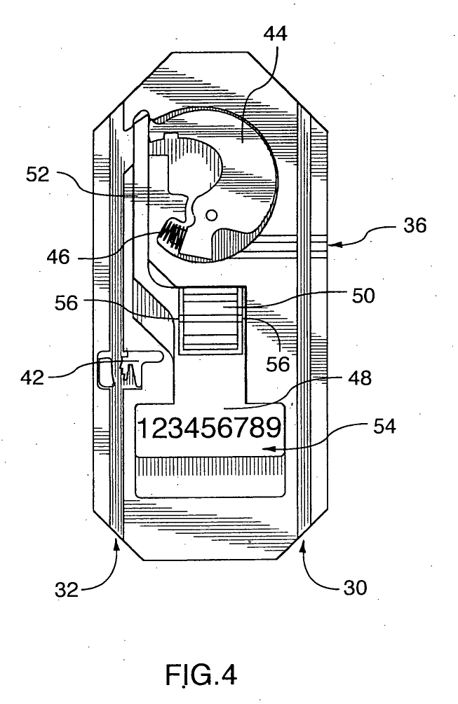

The button 50 is connected to the slider 48 by frangible webs 56, as shown in FIG. 4; extends from the slider 48 exteriorly of the housing 28, as best seen in FIG. 1; and is adapted to traverse the length of the elongate slot 38 in the housing 28 upon movement of the slider 48 between its first position and its second position.

The button 50 permits manual manipulation of the slider 48 from its first position to its second position and, when the latch 44 is disposed at its second position, from its second position to its first position.

The pawl 42 is mounted interiorly of said housing 28 to project into the second passageway 32, as seen in FIG. 4. As will be readily appreciated by persons of ordinary skill in the art, the pawl 42 of this embodiment is similar in construction to that found on some conventional cable ties.

Turning now to the security strap 24 shown in FIG. 1, same will be seen to include an enlarged head 58 and a body 60. The head 58 is greater in dimension than the first passageway 30. The body 60 extends from the head 58; is ribbed or serrated and elongate; has a tail end 62; and is of a girth smaller in dimension than the passageways 30,32. As will also be readily appreciated by persons of ordinary skill in the art, the body 60 of this embodiment is similar in construction to that found on some conventional cable ties.

The key 26 includes a manually grippable handle portion 64 and a trough-shaped pintle portion 66 extending from the handle portion 66. The trough-shaped pintle portion 66 has a cross-section substantially similar in dimension to the cross-section of the keyway 36, to permit insertion therein.

The security device 22 (with the housing cover portion 28A removed for clarity) is shown with the lock mechanism 40 disposed in its unlocked configuration in FIG. 4.

With the device 22 so configured, a strap 24 can be threaded tail end 62 first in sequence through the first passageway 30 and then through the second passageway 32, as indicated by the sequence of FIGS. 5,6. The smaller dimension of the elongate body 60 of the security strap 24 relative to the passageways 30,32 renders this a relatively simple process.

As the security strap 24 traverses the second passage 32, the pawl 42 falls into the interdental spaces on said elongate body 60 so as to arrest motion of the elongate body 60 of said security strap 24 through the second passageway 32 otherwise than tail end 62 first. At the same time, the enlarged head 58 of the security strap 24 precludes passage of the head 58 through the first passageway 30. The housing 28 and the pawl 42 thus form a linking means for receiving said strap 24 and, when in receipt of said strap 24, for securely linking longitudinally spaced-apart portions thereof.

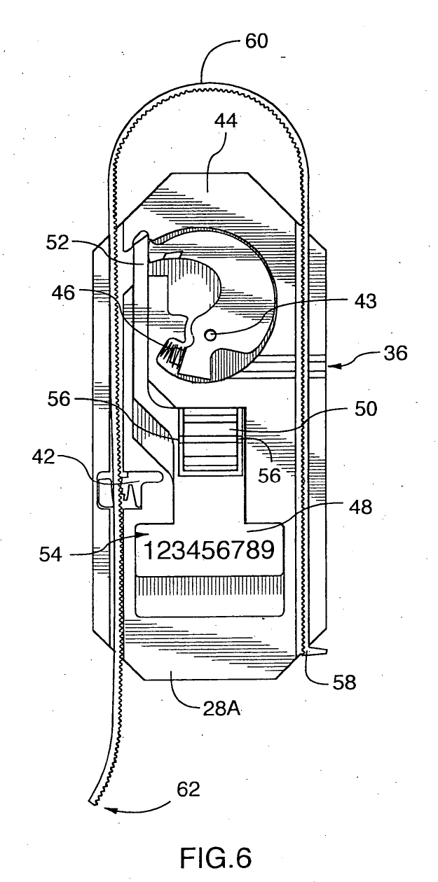

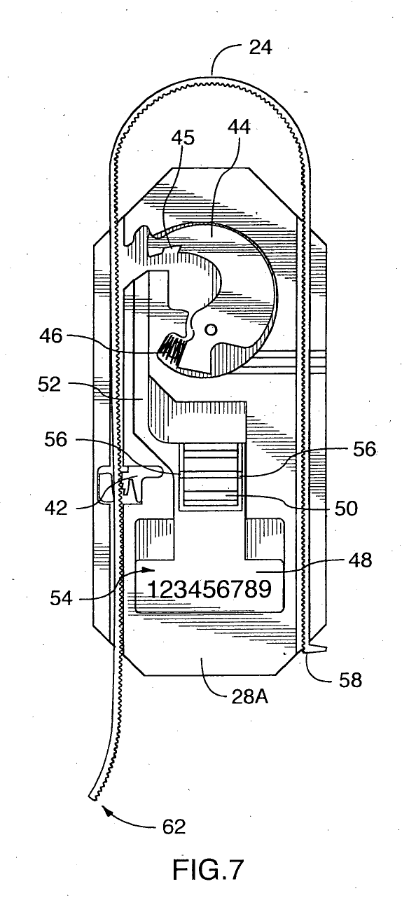

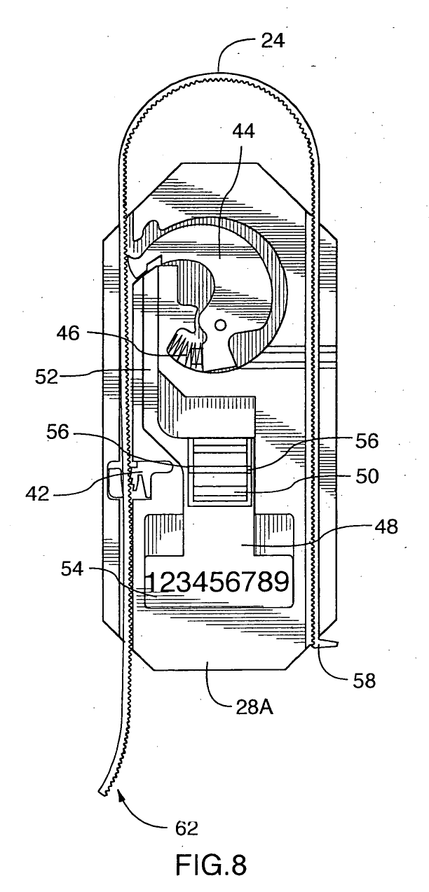

After the security strap 24 has been inserted, as shown in FIG. 6, the slider 48 can be moved to its second position, as shown in FIG. 7. This permits the spring 46 to urge the latch 44 towards its first position, in abutment with the security strap 24, as shown in FIG. 8. Further, it permits the indicia 54 to be visible through the viewing window 34. With the latch 44 disposed as shown in FIG. 8, it will be understood that the slider 48 cannot be returned to its first position.

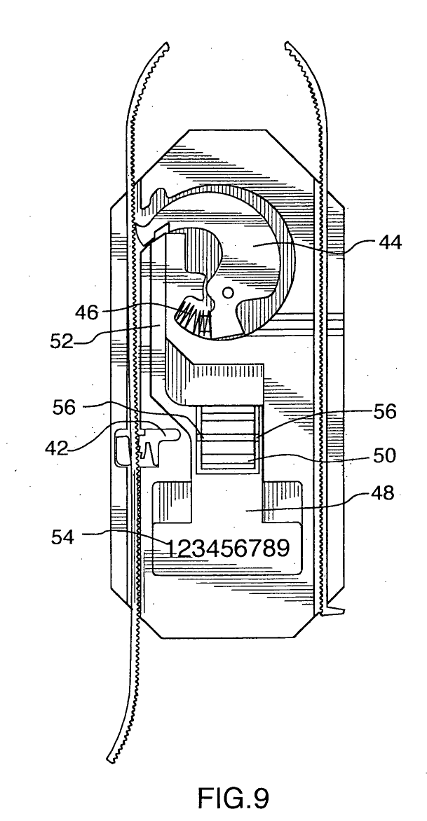

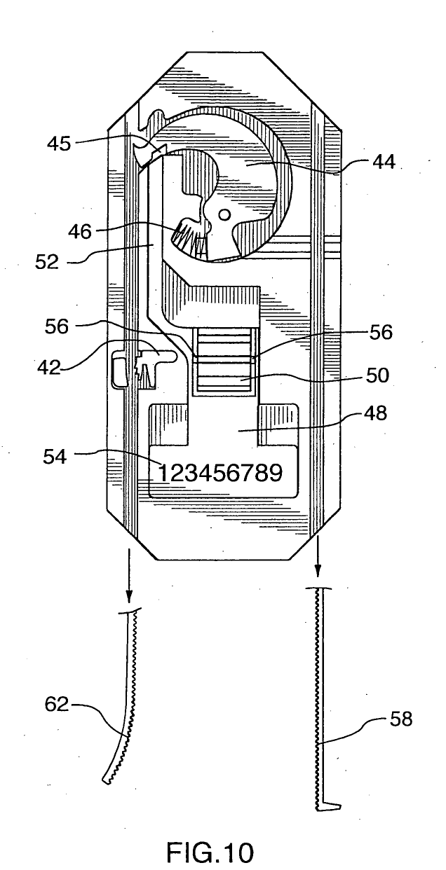

In the preferred embodiment illustrated, the linking means defined by the housing 28 and the pawl 42 is adapted to release any strap operably received thereby if the strap is bisected intermediate the spaced-apart portions. That is, with the strap split, the part including the enlarged head can be readily removed from the first passageway 30, since its retraction therefrom is no longer impeded by the tail end 62; similarly, the part of the strap including the tail end 62 can traverse completely the second passageway 32, since its progress is no longer arrested by the enlarged head 58. Such removal is illustrated by the sequence of FIGS. 9, 10. As the tail end 62 of the strap 24 passes the latch 44, the spring 46 urges the latch 44 to its first position, as shown FIG. 11.

With the security strap 24 fully removed from the structure, the key 26 may be inserted into the keyway 36. As illustrated by the sequence of FIGS. 11,12, the latch 44 and the keyway 36 are positioned such that such insertion of the key 26 into the keyway 36 drives the latch 44 to its second position.

With the latch 44 so positioned, the button 50 can be manipulated to return the slider 48 to its first position, for subsequent receipt of a new security strap 24, as illustrated in FIG. 5.

The security system 20 can be used with any conventional piece of luggage that is of the type that has cooperating parts adapted to receive the shackle of a padlock or the like to permit the piece of luggage to be locked closed. For example, the security system can be used with a piece of luggage having a hasp; a piece of luggage having a zipper with dual pulls that can be locked together; or a piece of luggage that has a zipper with a single pull with a terminally positioned lug, in which case the zipper pull and the lug can be locked together. With the security strap operably received by the cooperating parts of such a piece of luggage (not shown), and said strap operably received by the linking means, the piece of luggage cannot be opened.

A method, for use with a piece of luggage of the above-noted type, which provides evidence if the piece of luggage has been opened by unauthorized persons forms another aspect of the invention.

In a preferred embodiment of the method, a controlled supply of security packages (not shown) are provided to check-in personnel at an airport. Each package consists of a security device and a security strap as hereinbefore described. Also enclosed is a self-adhesive label. Each security device has unique indicia etched or otherwise permanently associated with its slider. The security strap and the label also bear the unique identifier of the security device with which they are packaged.

One such package is provided for each piece of luggage checked by a passenger, and the check-in staff provides for the operable receipt of the security strap by the cooperating parts of the luggage and the linking means of the security device, whereby the piece of luggage cannot be opened. The label is affixed to the boarding pass of the passenger.

A controlled supply of security keys and security straps as described hereinbefore is provided to authorized persons, namely, airport security personnel. In the event that such persons wish to visually inspect the contents of the piece of luggage, they can break the strap and remove it, as indicated by the sequence of FIGS. 8,9,10, to permit access to the contents of the piece of the luggage. After inspection has been completed, such persons can insert the key, as indicated by FIGS. 11, 12, whereupon a new strap can be inserted.

Unauthorized persons, of course, can also gain access to the contents of the luggage by breaking the strap. However, upon removing the broken strap 24, the latch 44 will tend to be urged by the spring 46 to its first position. If, prior to removing the broken strap, the unauthorized person attempts to immobilize the latch 44 at its position in FIG. 8 by applying force to the latch 44 via the slider 48, the frangible webs 56 will break, whereupon the button 50 will become detached (not shown). If, after the broken strap 24 has been removed and the latch 44 has moved to its first position, an unauthorized person attempts to back the latch 44 away from its first position by applying force to the latch 44 via the slider 48, the elongate arm 52 of the slider 48 will engage the notch 45 in the latch 44, thereby to arrest movement of the latch 44. If additional force is applied, the frangible webs 56 will break.

It will be evident that the boarding pass serves as a convenient luggage claim receipt, to match a piece of luggage with its owner, since the indicia on the label on the boarding pass should match the indicia on the security device.

In situations where passengers are required to attend to claim their baggage (in contrast to self-serve luggage claim systems), the security system will be inspected by the airline personnel when the luggage to which it is affixed is to be transferred to the passenger. If it is evident from such inspection that the indicia on the security device, the security strap and the label match, the passenger and airline have good reason to believe that the bag has not been opened. If the indicia on the security strap does not match that of the security strap and the label, the passenger and airline have good reason to believe that the bag has been opened by authorized persons. If the security device is missing or the button thereof is detached, the passenger and airline personnel have good reason to believe that the contents have been tampered with, whereupon appropriate action can be taken, depending upon the type of violation.

While but two embodiments of the present invention have been herein shown and described, it will be understood that numerous modifications can be made without departing from the spirit or scope of the invention.

For example, whereas a security system is described as a preferred embodiment of the present invention, it should be understood that the security device, in and of itself, forms an aspect of the present invention, as do security straps and keys adapted for use therewith.

Further, whereas the security device of the preferred embodiment includes a single pawl mechanism, it will be evident that dual pawl mechanisms could readily be employed. In this event, the strap would have two tail ends, and each tail end would be inserted tail end first into a respective passageway, for gripping engagement by a respective pawl.

It is evident that the key adds a measure of security in the event that inventory control of the supply of security straps is lost, or counterfeit straps are produced, since in any event, new security straps cannot be inserted without the use of the key. However, it should be understood that the key, the latch, the spring and the slider are optional. Further, whereas the key as shown has a relatively simple cross-section, more complex cross-sections can be utilized, for enhanced security, if desired. Further, other locking mechanism may be employed.

Yet further, whereas the security strap illustrated herein is serrated or ribbed, in the manner of some conventional cable ties, it will be understood that other configurations of the cable tie are possible, provided suitable modification is made to the pawl or such other gripping mechanism as may be employed to provide the contemplated linking functionality. For example, the security strap could be provided with longitudinally spaced apertures, into which the pawl can engage upon progression of the security strap through the passageway.

Additionally, whereas a use of the security system is described in the context of a process wherein the baggage is inspected by airline personnel prior to return to the passenger, it will be evident that the tamper evidence functionality of the security system does not require such involvement of airline personnel. Further, it will be evident that the security device provides a convenient mechanism to permit the passenger to identify his or her piece of luggage in a self-serve luggage claim system, by matching the number on the label affixed thereto with the number on the security device.

Moreover, whereas the use described related to airlines, it will be readily appreciated that the security device could be readily employed in other transportation systems wherein passengers are separated from their luggage.

A yet further use of the security system is in hotels. It is commonplace for persons checking-out of a hotel to leave their luggage with the hotel for a period of time if their departure from the hotel is to be delayed. In such circumstances, a supply of security systems could be available at the front desk, and given to the persons checking out for affixation to their luggage. This would provide the departing guest a measure of security that their bags had not been tampered with when in the custody of the hotel. This security would be even greater in circumstances wherein the luggage itself has no working lock mechanism.

It should also be understood that, whereas it is hereinbefore specified only that the strap used with the security device is disposable (since it is broken after use, and thus not suitable for reuse), it is preferable also that the security device be constructed in a low-cost manner, and used as a disposable product, since reuse of the security device, although possible, would require same to be collected after use, at some inconvenience.

Even further modifications are possible, and considered to fall within the scope of the present invention. Accordingly, it should be understood that the present invention is considered to be limited only by the claims appended hereto, purposively construed.

1. A security device for use with a disposable strap and a piece of luggage, the piece of luggage having cooperating parts adapted to receive the shackle of a padlock or the like to permit the piece of luggage to be locked closed, said security device comprising:
a linking means for receiving said strap and, when in receipt of said strap, for securely linking longitudinally spaced-apart portions thereof such that, when said strap is operably received by said cooperating parts and said strap is operably received by the linking means, said piece of luggage cannot be opened.

2. A security device according to claim 1,
wherein the linking means includes a lock mechanism manipulable between a locked configuration and an unlocked configuration, and wherein the linking means is adapted to receive said strap only when the lock mechanism is in the unlocked configuration.

3. A security device according to claim 1, wherein the linking means is adapted to release any strap operably received thereby if the strap is bisected intermediate the spaced-apart portions.

4. A security device for use with a disposable strap, a key and a piece of luggage, the piece of luggage having cooperating parts adapted to receive the shackle of a padlock or the like to permit the piece of luggage to be locked closed, said security device comprising:
a linking means for receiving said strap and, when in receipt of said strap, for securely linking longitudinally spaced-apart portions thereof such that, when said strap is operably received by said cooperating parts and said strap is operably received by the linking means, said piece of luggage cannot be opened,
wherein the linking means includes a lock mechanism manipulable upon insertion of said key from a locked configuration to an unlocked configuration, and wherein the linking means is adapted to receive said strap only when the lock mechanism is the unlocked configuration.

5. A security device according to claim 4, wherein the linking means is adapted to release any strap operably received thereby if the strap is bisected intermediate the spaced-apart portions.

6. A disposable security strap for use as the disposable strap with which the security device of claim 5 is used.

7. A security key for use as the key with which the security device of claim 5 is used.

8. A security system comprising:
the security device of claim 5;
the security strap of claim 6; and
the security key of claim 7.

9. A security system according to claim 6, wherein the linking means comprises:
a housing having a pair of passageways defined therethrough, said pair of passageways consisting of a first passageway and a second passageway.

10. A security system according to claim 9,
wherein the security strap includes a serrated, elongate body having a tail end and being of a girth smaller in dimension than the passageways so as to permit passage therethrough; and
further comprising a pawl mounted to said housing to project into the second passageway and adapted to fall into the interdental spaces on said elongate body so as to arrest motion of the elongate body of said security strap through the second passageway otherwise than tail end first.

11. A security system according to claim 10,
wherein the security strap has an enlarged head from which the elongate body extends, the head being greater in dimension than the first passageway so as to preclude passage therethrough.

12. A security system according to claim 9, wherein the lock mechanism includes a latch mounted interiorly of the housing for movement between a first position, whereat a portion of the latch lies across one of the passageways to preclude traverse by the security strap, and a second position, whereat the latch is disposed apart from said one of the passageways, to permit traverse of the security strap therethrough.

13. A security system according to claim 12, wherein the lock mechanism further comprises a spring biasing the latch for movement to its first position.

14. A security system according to claim 12, wherein at the first position, the latch lies across the second passageway.

15. A security system according to claim 12, wherein the housing defines a keyway shaped to permit access to the latch by the key, the latch and the keyway being positioned such that insertion of the key into the keyway urges the latch to its second position.

16. A security system according to claim 13, wherein the lock mechanism further comprises a slider mounted interiorly of the housing for sliding movement between a first position and a second position,
the first position of the slider being a position of interference with the first position of the latch such that movement of the latch to its first position is precluded when the slider is at its first position, and movement of the slider to its first position is precluded when the latch is at its first position
the second position of the slider being a position of non-interference, thereby to permit movement of the latch between its first position and second position.

17. A security system according to claim 16, wherein the first position of the slider defines the unlocked configuration of the lock mechanism.

18. A security system according to claim 16, wherein the housing has an elongate slot defined therein, and further comprising a button rigidly extending from the slider exteriorly of the housing and adapted to traverse the length of said slot upon movement of the slider between its first position and its second position, the button being for manual manipulation of the slider between its first position and its second position.

19. A security system according to claim 16, wherein the housing defines a viewing window and the slider has indicia visible through the viewing window when the slider is disposed at its second position.

20. A method, for use with a piece of luggage having cooperating parts adapted to receive the shackle of a padlock or the like to permit the piece of luggage to be locked closed, which provides evidence if the piece of luggage has been opened by unauthorized persons, said method comprising the steps of:
providing for the operable receipt by the cooperating parts of a security strap according to claim 4, and providing for the operable receipt of said security strap by the linking means of a security device according to claim 3,
providing a security key according to claim 5 and a supply of security straps according to claim 4 to said authorized persons.
